(19) United States
(12) Patent Application Publication
(10) Pub. No.: US 2007/0152913 A1
(43) Pub. Date: Jul. 5, 2007

(54) Driving method for significantly reducing addressing time in plasma display panel

(75) Inventors: Qun Yan, Wallkill, NY (US); Robert G. Marcotte, New Paltz, NY (US); Norifusa Isobe, New Paltz, NY (US)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: Matsushita Electric Industrial Co., Ltd.

(21) Appl. No.: 11/323,856

(22) Filed: Dec. 30, 2005

(51) Int. Cl. G09G 3/28

(52) U.S. Cl. 345/67

(57) ABSTRACT

There is provided a method for controlling a pixel in a plasma display. The method includes applying a first voltage to a first electrode, a second voltage to a second electrode, and a third voltage to a third electrode to generate a first plasma discharge of a dischargeable gas in the pixel. The method also includes applying a forth voltage to the first electrode, a fifth voltage to the second electrode, and a sixth voltage to the third electrode to generate a second plasma discharge of the dischargeable gas in the pixel. The first plasma discharge establishes a first wall potential between the first electrode and the third electrode. The second plasma discharge establishes a second wall potential between the first electrode and the third electrode. The second wall potential is offset from the first wall potential. There is also provided a plasma display and a controller that employ the method.

### BACKGROUND OF THE INVENTION

1. Field of the Invention

The present disclosure relates to plasma displays, and more particularly, to a technique of generating voltages for electrodes of a pixel in a plasma display in a manner that significantly reduces the address time by improving the wall voltage establishment in both sustain gap and plate gap while retaining low level of background glow.

2. Description of the Related Art

Most commercial plasma display panels (PDP's) are of the surface discharge type. The constitution of a plasma display panel of the prior art is described below with reference to the accompanying drawing.

FIG. 1 is a perspective view of a portion of a conventional AC color plasma display panel 100. PDP 100 includes a front plate assembly 103 and a back plate assembly 106. Front plate assembly 103 includes a front plate 110, which is a glass substrate, sustain electrodes 111 and scan electrodes 112 for each row of pixel sites. Front plate assembly 103 also includes a dielectric glass layer 113 and a protective layer 114. Protective layer 114 is preferably made of magnesium oxide (MgO).

Back plate assembly 106 includes a glass back plate 115 upon which plural column address electrodes 116, i.e., data electrodes, are located. Data electrodes 116 are covered by a dielectric layer 117. Barrier 118 separates front plate assembly 103 and back plate assembly 106. Red phosphor layer 120, green phosphor layer 121, and blue phosphor layer 122 are located on top of the dielectric layer 117 and along the sidewalls created by barriers 118. Each pixel of PDP 100 is defined as a region proximate to an intersection of (i) a row including sustain electrode 111 and scan electrode 112, and (ii) three column address electrodes 116, one for each of red phosphor layer 120, green phosphor layer 121, and blue phosphor layer 122.

FIG. 2 is a side view of a portion of PDP 100, specifically of a sub-pixel 140 corresponding to green phosphor layer 121, taken along a plane perpendicular to a long dimension of address electrode 116. Referring to FIG. 2, in a surface discharge type PDP such as PDP 100, an inert gas mixture, such as Ne—Xe, fills a space 125 between front plate assembly 103 and back plate assembly 106.

Barrier ribs 118 separate color channels formed by barrier ribs 118, front plate assembly 103 and back plate assembly 106. Sub-pixels 140 are formed as an area bounded by the sides of barrier ribs 118 and the area defined by sustain electrodes 111. A gas discharge 145 is generated by a voltage applied between sustain electrode 111 and scan electrode 112, which creates vacuum ultraviolet (VUV) light that excites the red, green, and blue phosphor layers, respectively to emit visible light. For example, green phosphor 121, as shown in FIG. 2, is excited by the VUV light to generate green light from green phosphor layer 121.

FIG. 3 is another side view of PDP 100, taken along a plane parallel to the long dimension of address electrode 116, and showing sub-pixel 140 in a plane perpendicular to the plane of FIG. 2. FIG. 3 shows sub-pixel 140, which is defined as an area that includes intersections of an electrode pair of a transparent sustain electrode 111 and scan electrode 112 on front plate 110, and data electrode 116 on back plate 115. Transparent sustain electrode 111 has an adjacent bus electrode 150 connected thereto, and transparent scan electrode 112 has an adjacent bus electrode 155 connected thereto. Bus electrodes 150 and 155 are typically opaque.

The operating sustain voltage of PDP 100 is determined by a geometry of a sustain gap 130, dielectric layer 113, the particular gas mixture used, and a secondary electron emission coefficient of the protective MgO layer 114 on front plate 110. The visible light generated in the sustain discharges is responsible for the brightness of a color PDP. Initiation of sustain discharges is achieved by an addressing discharge through a plate gap 131 prior to sustain discharges, which is further described below. A full color image is generated by appropriately controlling the driving voltage on sustain electrodes 111, scan electrodes 112, and addressing electrodes 116.

In operation, as shown in FIG. 4, the plasma display partitions a frame of time into sub-fields, each of which produces a portion of the light required to achieve a proper intensity of each pixel. Each sub-field is partitioned into a setup period, an addressing period and a sustain period. The sustain period is further partitioned into a plurality of sustain cycles.

The setup period resets any ON pixels to an OFF state, and provides priming to the gas and to the surface of protective layer 114 to allow for subsequent addressing. In the setup period, it is desirable that each interior surface of the pixel's electrodes is placed at a voltage very close to a firing voltage of the gas.

During the addressing period, the sustain electrodes are driven with a common potential, while scan electrodes are driven such that a row of pixels is selected so that pixels in that row can be addressed via an addressing discharge triggered by an application of a data voltage on a vertical column electrode. Thus, during the addressing period, each row is sequentially addressed to place desired pixels in the ON state.

During the sustain period, a common sustain pulse is applied to all scan electrodes to repetitively generate plasma discharges at each sub-pixel addressed during the addressing period. That is, if a sub-pixel is turned ON during the address period, the pixel is repetitively discharged in the sustain period to produce a desired brightness.

In order to exhibit a full color image on a plasma display panel (PDP) from a video source, a proper driving scheme is needed to achieve sufficient gray scale and minimize motion picture distortion. In AC plasma display panels, a widely used driving scheme to accomplish gray scale in pixels is the so called ADS (address display separated) suggested by Shinoda (Yoshikawa K, Kanazawa Y, Wakitani W, Shinoda T and Ohtsuka A, 1992 Japan. Display 92, 605).

Referring to FIG. 4, it can be seen that in this method, a frame time of 16.7 milliseconds (one TV field) is divided into eight sub-fields, designated as SF1-SF8. Each of the eight sub-fields is further divided into an address period 405 and a sustain period, i.e., display period 410. Pixels previously addressed during address period 405 are turned on and emit light during sustain period 410. The duration of sustain period 410 depends on the particular sub-field. By controlling the addressing of each sub-pixel for a given pixel during addressing period 405, the intensity of the pixel can be varied to any of the 256 gray scale levels.

As shown in FIG. 4, the time used in addressing consumes a large fraction of the frame time (16.7 ms) because each line of the display has to be addressed in every sub-field. To minimize the motion picture distortion (MPD) due to time-modulation brightness schemes such as ADS, more sub-fields, such as 10 to 12 sub-fields, are required. A plasma display panel used as an HDTV (high definition TV, 720p, or 1080i) set or even a FHD (full high-definition TV, 1080p) set requires more lines to display better images. Scan pulse timing 415 in each sub-field is the sum of the addressing time of every horizontal line (scan electrodes), therefore the total scanning time in a TV display field (16.7 ms) is the multiple of the number of sub-fields and the scanning pulse timing in each sub-field.

More sub-fields and higher resolution PDP TV sets requires a shorter total scanning time to leave enough time for the sustain periods which determine the brightness of the display. In order to achieve shorter total scanning time, faster addressing in each sub-pixel is needed. In order to achieve a fast and reliable addressing, the delay time before the start of the address discharge should be kept as short as possible and the jitter of the discharge should also be kept as low as possible.

The delay time of the start of the discharge, also called the formative delay, is determined by the electric field across the gas in the plate gap 131. The stronger the field across the gas the shorter the formative delay of the discharge. The jitter of the discharge, also defined as statistical delay, is mainly due to the quantity of priming particles, such as UV photons, electrons, ions, and metastable atoms, present in the gas volume 125 during the address period. An increase in the quantity of priming particles left at the address time lowers the jitter occurring during addressing, i.e., results in a shorter statistical delay.

The wall charge is defined as charge accumulation on the dielectric surfaces, including the surface of protective layer 114 and the surfaces of phosphor layers 120, 121 and 22, due to gas discharge. The wall charge on each surface has its own charge distribution caused by the gas discharge. The wall charge provides extra voltage, defined as wall voltage, across the gas. Wall voltage may be measured as plate gap wall voltage or sustain gap wall voltage. The total voltage across the gas is the difference between wall voltage and an external voltage applied to the electrodes.

The addressing time is determined by how fast the addressing discharge occurs. The addressing discharge is initiated or triggered by a plate gap discharge which determines the formative delay of the addressing discharge. The stronger the electric field across plate gap 131, the shorter the formative delay. Higher wall voltage establishment in the plate gap helps to provide the highest possible electric field across the plate gap at addressing time, which leads to the fastest formative delay. Also because of the higher electric field across the plate gap, priming particles (such as electrons) can be easily released from protective layer 114 on the front plate to significantly reduce the statistical delay. As a result, a faster address discharge can be achieved.

To reduce the cost of data driving circuits, the address voltage applied on the address electrodes is kept below about 80V. There is therefore a need to provide a stronger field in the plate gap to reduce addressing time, without increasing the address voltage. There is also a need to provide a better priming condition at the time of addressing. Furthermore, there is a need to reduce the addressing time of plasma display panels.

### SUMMARY OF THE INVENTION

There is provided a method for controlling a pixel in a plasma display. The method includes applying a first voltage to a first electrode, a second voltage to a second electrode, and a third voltage to a third electrode to generate a first plasma discharge of a dischargeable gas in the pixel. The method also includes applying a forth voltage to the first electrode, a fifth voltage to the second electrode, and a sixth voltage to the third electrode to generate a second plasma discharge of the dischargeable gas in the pixel. The first plasma discharge establishes a first wall potential between the first electrode and the third electrode. The second plasma discharge establishes a second wall potential between the first electrode and the third electrode. The second wall potential is offset from the first wall potential. There is also provided a plasma display and a controller that employ the method.

### BRIEF DESCRIPTION OF THE DRAWINGS

FIG. 1 is a perspective view of a conventional color plasma display structure according to the prior art.

FIG. 2 is a side view of a sub-pixel of the color plasma display panel of FIG. 1, taken along a plane perpendicular to a long dimension of an address electrode.

FIG. 3 is another side view of a sub-pixel of the color plasma display panel of FIG. 1, taken along a plane parallel to the long dimension of the address electrode, and showing the sub-pixel in a plane perpendicular to the plane of FIG. 2.

FIG. 4 is a diagram of a driving scheme of an address display separation (ADS) gray scale technique, showing a frame time divided into sub-fields.

FIG. 5 is a graph of waveforms according to the present invention, for voltages applied to a scan electrode, a sustain electrode, and a data electrode of a sub-pixel in a plasma display structure.

FIG. 6A is a waveform graph showing the voltage difference between scan and sustain electrodes (Yab) and a sustain gap wall voltage. Wall voltage Wab(NA) is a wall voltage evolution in the sustain gap when there is no address discharge in an immediately previous sub-field, and wall voltage Wab(A) is a wall voltage evolution in the sustain gap when there is an address discharge in the immediately previous sub-field.

FIG. 6B shows the voltage difference between scan and data electrodes (Yad) and a plate gap wall voltage between scan and data electrodes. Wall voltage Wad(NA) is a wall voltage evolution in the plate gap when there is no address discharge in an immediately previous sub-field, and wall voltage Wad(A) is a wall voltage evolution when there is an address discharge in the immediately previous sub-field.

FIG. 7 is a graph of the statistical delay (Ts) of addressing discharges at three different sub-pixels driven by the waveform of the present invention, and their comparison with Ts of addressing discharges resulting from conventional waveforms.

FIG. 8 is a graph of an alternative embodiment of the waveforms according to the present invention.

FIG. 9 is a graph of another embodiment of the waveforms according to the present invention.

FIG. 10 is a graph of yet another embodiment of the waveforms according to the present invention.

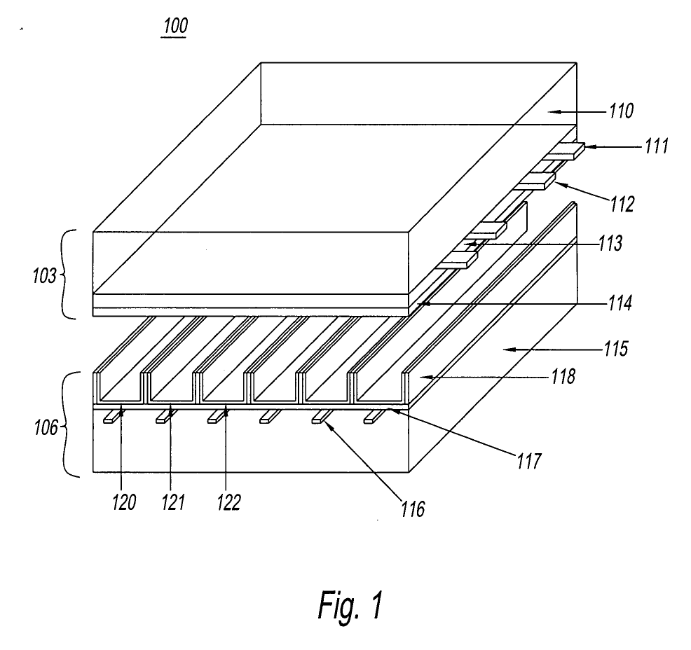

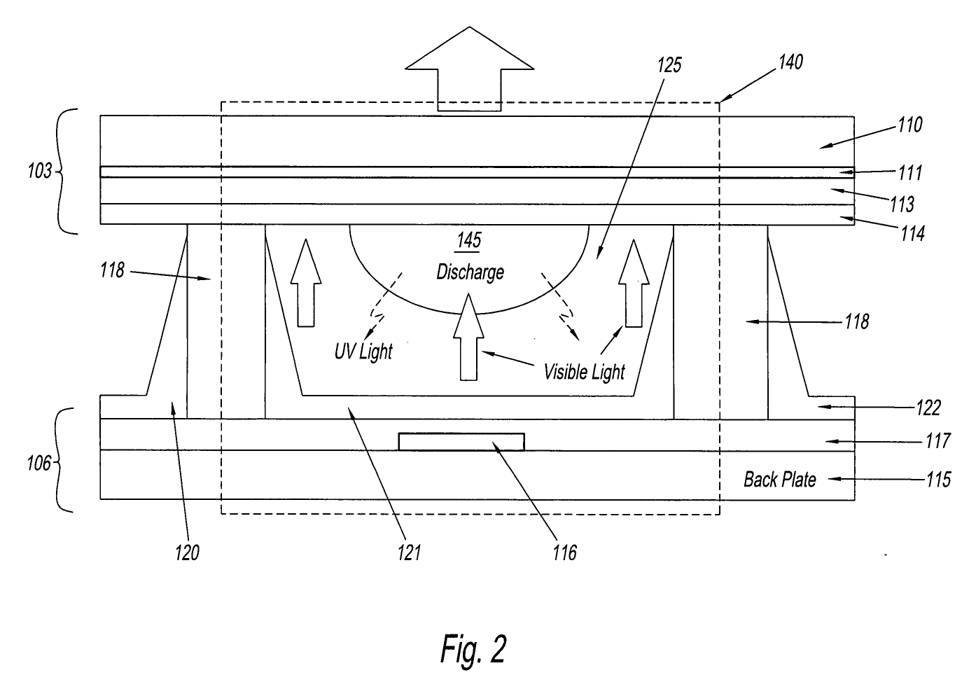

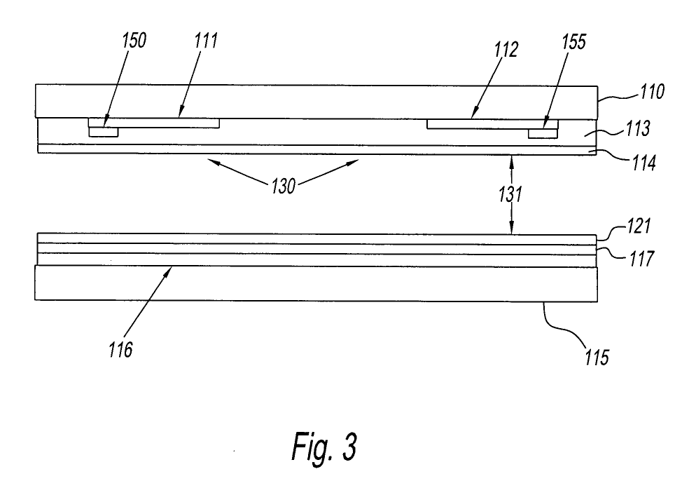

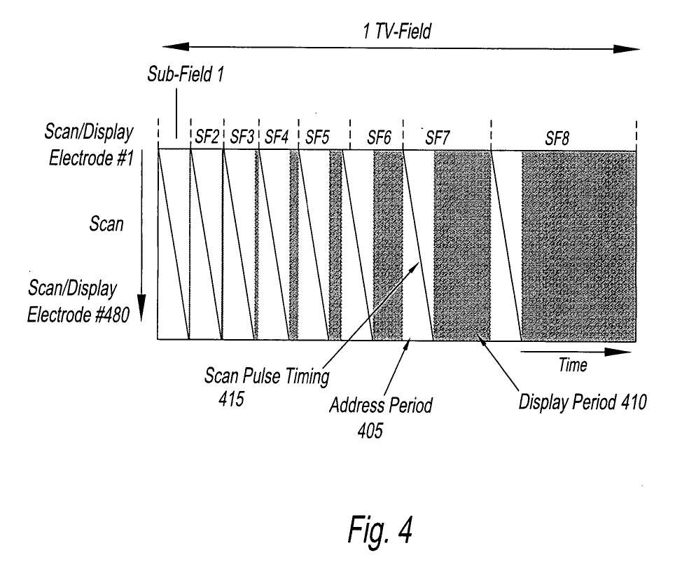

### DESCRIPTION OF THE INVENTION

The present invention provides waveform techniques for activating a strong plate gap discharge before an addressing period, and before or during a ramp setup period. The waveforms of the present invention result in a greater wall voltage across the plate gap and better distribution of wall voltage (or potential) across the plate gap by introducing a plate gap discharge prior to, or during, the ramp setup period. A well built-up wall voltage across the plate gap can trigger a faster addressing discharge, thus allowing for a significant reduction of the addressing time.

In one embodiment, there is provided a method for controlling a pixel in a plasma display. The method includes applying a first voltage to a first electrode, a second voltage to a second electrode, and a third voltage to a third electrode to generate a first plasma discharge of a dischargeable gas in the pixel. The method also includes applying a forth voltage to the first electrode, a fifth voltage to the second electrode, and a sixth voltage to the third electrode to generate a second plasma discharge of the dischargeable gas in the pixel. The first plasma discharge establishes a first wall potential between the first electrode and the third electrode. The second plasma discharge establishes a second wall potential between the first electrode and the third electrode. The second wall potential is offset from the first wall potential. There is also provided a plasma display and a controller that employ the method.

There is also provided a controller for a plasma display that includes a module that applies a first voltage to a first electrode, a second voltage to a second electrode, and a third voltage to a third electrode to generate a first plasma discharge of a dischargeable gas in the pixel. The module also applies a forth voltage to the first electrode, a fifth voltage to the second electrode, and a sixth voltage to the third electrode to generate a second plasma discharge of said dischargeable gas in said pixel. The module applies voltages to the electrodes in a manner described in the method provided herein. There is further provided a plasma display including a first electrode, a second electrode, and a third electrode, and a controller that applies voltages to the electrodes in a manner described in the method provided herein.

In one embodiment, the waveform technique creates an offset of voltages applied to the scan and sustain electrodes sufficient to cause a discharge which results in wall charge being applied to the data electrode. In another embodiment, the waveform technique creates an offset of voltages applied to the scan and data electrodes, which also results in wall charge being applied to the data electrode. This accumulation of wall charge at the data electrode contributes to both a plate gap and sustain gap wall voltage that is very close to the breakdown voltage, for example, on the order of a few volts below the breakdown voltage, by the end of the setup period. As a result, a faster addressing can be accomplished.

In one embodiment, the waveform technique activates a strong plate gap discharge during the ramp setup period. A better wall charge build-up in the plate gap is created by the new waveform, which helps to trigger the address discharge faster. As a result, a significant reduction of addressing time is achieved. The waveform increases the voltage between front electrodes and back electrodes during the ramp setup period. Increasing the voltage on both scan electrodes and sustain electrodes at front plates relative to data electrodes at back plates during the ramp rise period can increase more wall charge built-up on data electrodes.

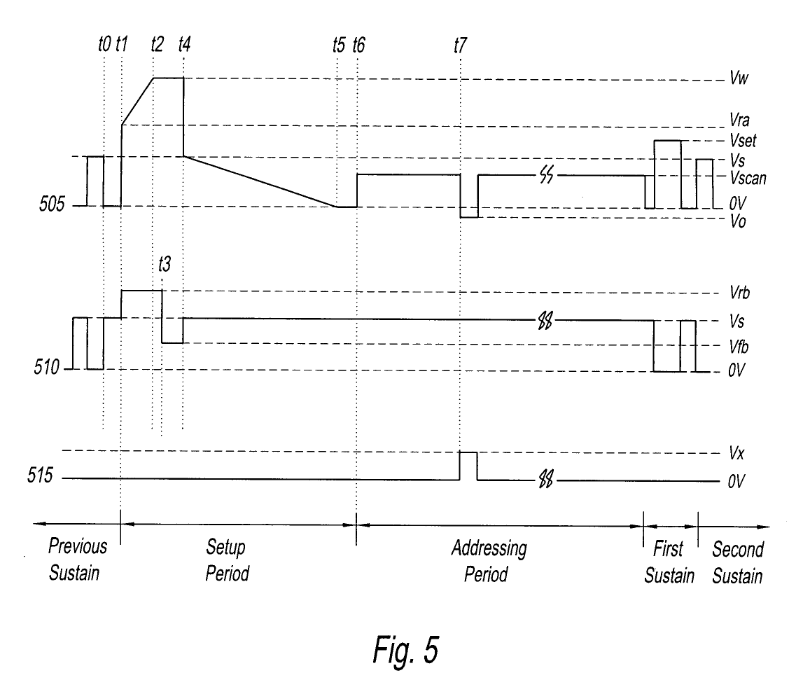

FIG. 5 is a graph of waveforms showing voltages applied to scan electrodes, sustain electrodes, and data electrodes. Waveform 505 represents voltages applied to scan electrode 112 over a period of time representing a sub-field, waveform 510 represents voltages applied to sustain electrode 111 over the period of time, and waveform 515 represents voltages applied to data electrode 116 over the period of time. The waveform time period of each sub-field is divided into five periods: a previous sustain period, a ramp setup period, an addressing period, a first sustain period, and a second sustain period.

The methods disclosed below, corresponding to FIGS. 5-10, are described below as being applied to PDP 100, described above. Reference to PDP 100 is exemplary. The methods disclosed herein may be used with plasma display panels of various configurations.

Referring again to FIG. 5, at time t0, a voltage applied to scan electrode 112 is reduced to zero Volts, i.e., 0 V, and a sustain voltage Vs is applied to sustain electrode 111. At the commencement of the setup period at time t1, voltage on scan electrode 112 is increased to ramp voltage Vra, and voltage on sustain electrode 111 is increased to ramp voltage Vrb. Preferably, the increase in voltage between Vs and Vra on scan electrode 112 is substantially equal to the increase in voltage from Vs to Vrb on sustain electrode 111. The voltage on scan electrode 112 is then increased gradually, i.e., ramped up, between times t1 and t2 until the voltage on scan electrode 112 at time t2 is at voltage Vw. The magnitude of voltage Vra is set to be greater than a breakdown voltage of plate gap 131, and voltage Vw is set so as to promote only a very weak discharge in plate gap 131.

At time t3, during the setup period and prior to ramping down the voltage on scan electrode 112, the voltage on sustain electrode 111 is quickly reduced to a voltage Vfb. This creates a large voltage difference between scan electrode 112 and sustain electrode 111. In one embodiment, the voltage drop on sustain electrode 111 is preferably in the range of about 50V to about 350V, depending on the pixel cell structure. This reduction of voltage occurs prior to a ramp-down period that occurs between times t4 and t5.

At time t4, the voltage is gradually decreased, i.e., ramped down, on scan electrode 112. During the ramp-down period between times t4 and t5, the scan electrode produces a very slight background glow as result of a small positive resistance discharge in plate gap 131 and sustain gap 130. At time t6, the beginning of the addressing period, the voltage on scan electrode 112 is increased to voltage Vscan. The step voltage Vscan at time t6 is used for preventing wall charge leakage and row isolation during addressing.

At time t7, the sub-pixel corresponding to electrodes 111, 112 and 116 is addressed. Data electrode 116 experiences an increase of voltage to voltage Vx. The voltage is lowered on scan electrode 112 at time t7 to negative voltage Vo in order to increase the voltage across the sustain gap and plate gap. As a result, a lower voltage Vx can be applied to the data electrode to achieve the desired voltage at time t7, as compared to the instance where the voltage applied to the scan electrode is zero. Voltage Vo is typically less than 10 volts for the purpose of reducing data voltage Vx. During the first sustain period, a first sustain pulse is applied to scan electrode 112 at voltage Vset, which is usually higher in magnitude and wider in time compared to the remaining pulses in the sustain pulse train.

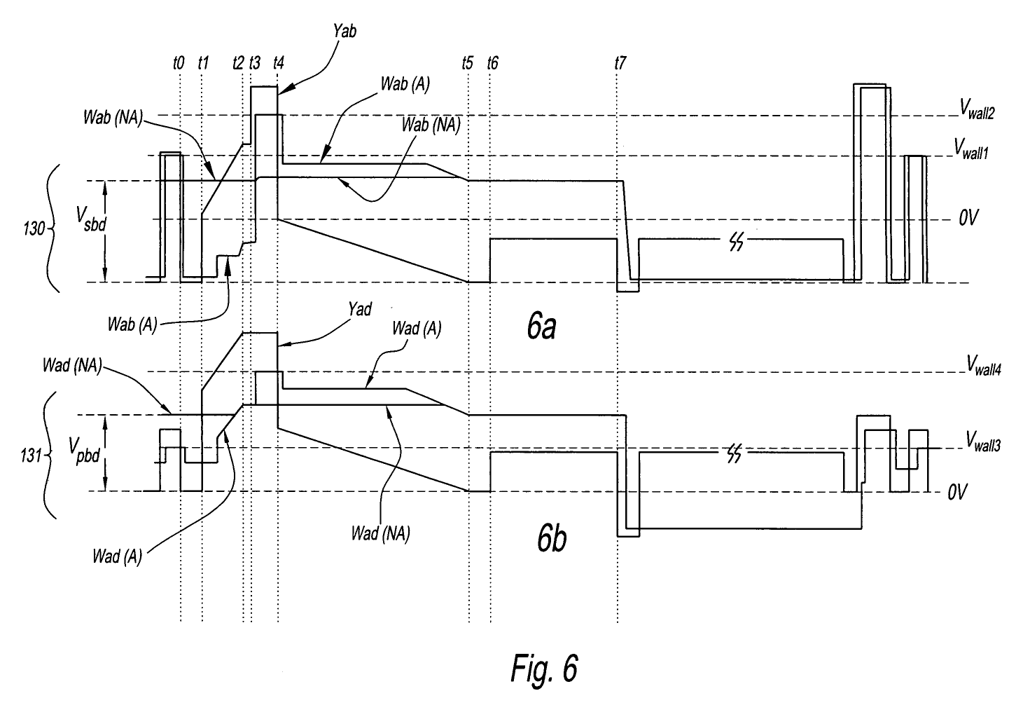

FIGS. 6A-6B are graphs of waveforms representing voltages in sustain gap 130 and plate gap 131 that result from the voltages applied to the electrodes represented by the waveforms of FIG. 5. FIGS. 6A and 6B demonstrate two operating conditions. In a first operating condition, the waveforms of FIG. 5 are applied to electrodes at which the pixel was NOT addressed during the previous sub-field. In a second operating condition, the waveforms of FIG. 5 are applied to electrodes at which the previous sub-field WAS addressed.

As is discussed below, the waveforms of FIGS. 6A and 6B behave differently, and the wall voltages in sustain gap 130 and plate gap 131 behave differently, depending onto the addressing condition of the previous sub-field. However, after the ramp setup period, the wall voltages of both sustain gap 130 and plate gap 131 are close to the breakdown voltage as shown in the FIGS. 6A and 6B, whether or not the previous sub-field was addressed. As a result, significantly faster addressing can be achieved with the waveforms of the present invention regardless of whether or not the immediately preceding sub-field was addressed.

FIG. 6A shows a voltage difference Yab between scan electrode 112 and sustain electrode 111, i.e., sustain gap voltage Yab. Yab refers to the difference in the voltage applied to the scan electrode versus the voltage applied to the sustain electrode. In the first operating condition, FIG. 6A also shows a wall voltage Wab(NA) of the gap between scan electrode 112 and sustain electrode 111, i.e. sustain gap wall voltage Wab(NA), when the pixel was not addressed in the previous subfield. In the second operating condition, FIG. 6A shows the wall voltage Wab(A) of the gap between the scan and the sustain electrodes, i.e. sustain gap wall voltage Wab(A), when the pixel was addressed in the previous sub-field.

FIG. 6B shows voltage difference Yad between the scan electrode and the data electrode, i.e. plate gap voltage Yad. In the first operating condition, FIG. 6B also shows the wall voltage Wad(NA) of the gap between scan electrode 112 and data electrode 111, i.e., plate gap wall voltage Wad(NA), when the previous sub-field was NOT addressed. In the second operating condition, FIG. 6B shows the wall voltage Wad(A) of the gap between the scan and the data electrodes), i.e., plate gap wall voltage Wad(A), when the previous sub-field WAS addressed.

Referring again to FIGS. 6A-6B, in the first operating condition, at time t0, sustain gap wall voltage Wab(NA) and plate gap wall voltage Wad(NA) both remain at a voltage that is very close to a breakdown voltage Vsbd of sustain gap 130 and a breakdown voltage Vpbd of plate gap 131, respectively. A rise of voltage on scan electrode 112 to voltage Vra at time t1 and ramp up of voltage on scan electrode 112 to voltage Vw at time t2, and the rise of voltage on sustain electrode to Vrb at t1, as shown in FIG. 5, does not cause a strong negative resistance discharge in this condition because the resultant difference between Yab and Wab(NA) is kept below the value of breakdown voltage of sustain gap 130.

Referring again to FIG. 5, the magnitude of Vra is set above the breakdown voltage of plate gap 131 and Vw is set up to promote only very weak discharge in plate gap 131. The voltage of Vw should be less than twice of the breakdown voltage of the plate gap. The sum of the voltage Vw and the voltage drop on sustain electrode 111 at time t3 should be kept lower than twice of the breakdown voltage of the gas in sustain gap 130. Therefore there is no strong discharge at time t3 in both sustain gap 130 and plate gap 131 because the voltage across the gas is less than the breakdown voltage in both gaps. For the same reason, the voltage change at time t4 on both scan and sustain electrodes also does not cause a strong negative resistance discharge.

A slow ramping down of voltage on scan electrode 112 from time t4 to t5 produces very little background glow as result of a small positive resistance discharge in plate gap 131 and sustain gap 130. Referring to FIGS. 6A and 6B, at time t6, sustain gap wall voltage Wab(NA) and plate gap wall voltage Wad(NA) are kept at a level very close to breakdown voltage Vsbd and breakdown voltage Vpbd, respectively. Therefore, the waveforms described in FIG. 5, in this embodiment, keep and stabilize the wall voltage close to the breakdown voltage and generate minimal background glow when there is no addressing in the previous sub-field.

Referring again to FIGS. 6A and 6B, in the second operating condition, where the previous sub-field was addressed, the situation is quite different. Because of a strong sustain discharge in a sustain period immediately preceding the setup period, sustain gap wall voltage Wab(A) and plate gap wall voltage Wad(A) are at low levels at time t0.

Referring again to FIG. 5, in plate gap 131, the rise of voltage on scan electrode 112 at time t1 to Vra creates a discharge followed by a weak positive resistance discharge in the sustain gap as well as the plate gap. As a result, wall voltages are built across both the sustain gap and the plate gap during time t1 and t2.

Referring again to FIGS. 6A and 6B, in the second operating condition, since sustain discharge involves gas discharge between scan electrodes 112 and sustain electrodes 111, the highest wall voltage across sustain gap 130 in the previous sustain period is at the level of Vwall1. The lack of a strong discharge in the plate gap during these sustain discharges results in a relatively small wall charge established in plate gap 131. The highest wall voltage across plate gap is at the level of Vwall3 during the sustain discharges of the previous sustain period. A strong negative resistance discharge in sustain gap 130 at time t3 due to the drop of voltage applied to sustain electrode 111, shown in FIG. 5 (waveform 510 at t3), results in a strong discharge, resulting in a significant wall charge on data electrode 116, and an increase in sustain gap wall voltage Wab(A) to Vwall2 instead of the highest sustain gap wall voltage Vwall1 in the last sustain period. The voltage drop at time t3 also increases plate gap wall voltage Wad(A) to Vwall4 instead of the highest plate gap wall voltage Vwall3 in the last sustain period.

Another strong negative resistance discharge in sustain gap 130 is expected at time t4. Weak positive resistance discharges occur in both sustain gap 130 and plate gap 131 during voltage ramping down period (from t4 to t5).

Thus, the plate gap wall voltage Wad(A) is significantly increased from Vwall3 to Vwall4 due to strong sustain gap discharge at time t3 as a result in the drop of voltage applied to sustain electrode 111. This is desirable because increased plate gap wall voltages Wad(A) before the ramp down period beginning at time t4 result in a more positive resistance discharge during the ramp down period, which in turn results in the establishment of a more stable plate gap wall voltage Wad(A) that is close to the breakdown voltage at time t5. As a result, a faster addressing can be accomplished. The above waveform results in a reduction of address time of approximately 50%.

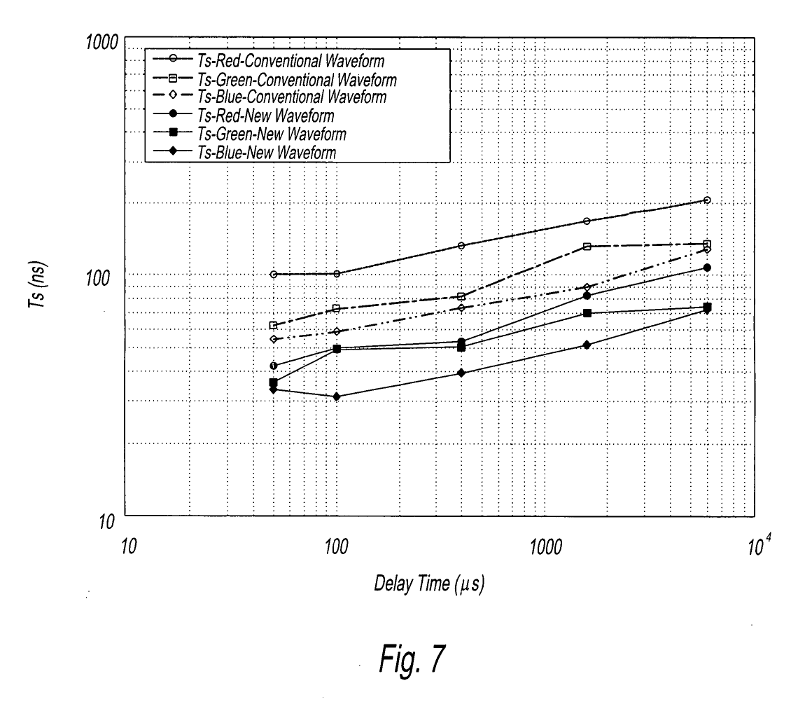

FIG. 7 is a graph of the statistical delay (Ts) of addressing discharges at three different sub-pixels driven by the waveform of the present invention, and their comparison with Ts of addressing discharges resulting from conventional waveforms. The graph shows Ts values, in nanoseconds, vs. delay time, in microseconds, for a red, green, and blue subpixel, each driven by a conventional waveform. The graph also shows Ts values for a red, green, and blue subpixel driven by a waveform according to the present invention. As demonstrated in the graph of FIG. 7, Ts values produced by the waveform of the present invention are about half of the Ts values produced by the conventional waveforms. These results clearly indicate that significantly faster addressing can be achieved with the waveforms of the present invention.

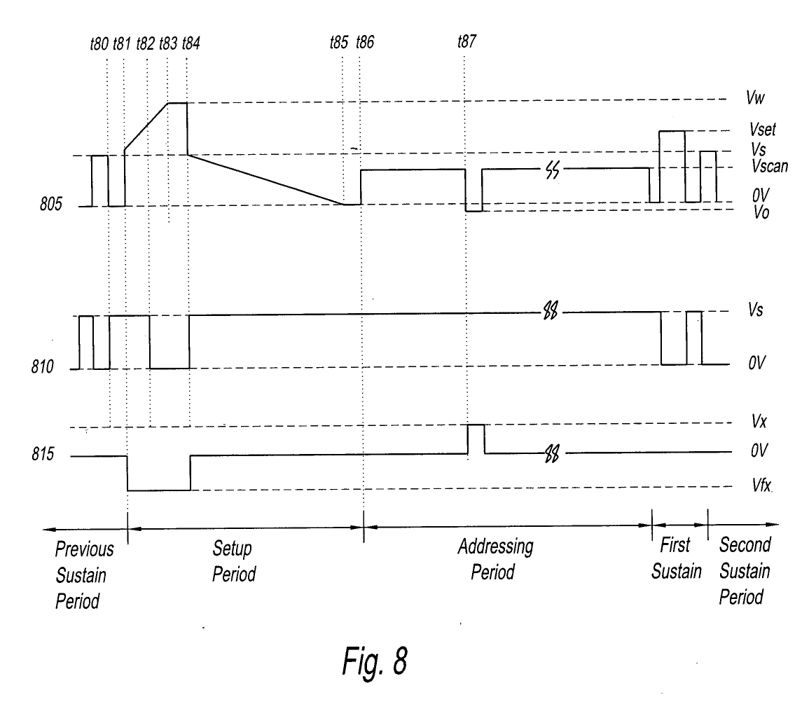

Referring to FIG. 8, an alternative embodiment of the waveform of the present invention is provided. Waveform 805 represents voltages applied to scan electrode 112 over a period of time representing a sub-field, waveform 810 represents voltages applied to sustain electrode 111 over the period of time, and waveform 815 represents the voltage applied to data electrode 116 over the period of time. The waveform time period of each sub-field is divided into a previous sustain period, a ramp setup period, an addressing period, a first sustain period, and a second sustain period.

In this embodiment, the waveforms of FIG. 8 are similar to the waveforms of FIG. 5. However, unlike FIG. 5, the waveform of FIG. 8 does not include a quick increase in voltage on either scan electrode 112 or sustain electrode 111. In this embodiment, a negative voltage Vfx is applied to data electrode 116 during the ramp up period between times t1 and t4. This negative voltage Vfx application is equivalent to positive Vra and Vrb in FIG. 5.

In this case, by applying a negative voltage Vfx in the ramp setup period, a strong discharge takes place across plate gap at time t81 if the previous sub-field is addressed. A strong build up of plate gap wall voltage Wad(A), similar to Vwall4 in FIG. 6, is established. Sustain gap voltage Yab and sustain gap wall voltage Wab(A) produced in this embodiment are similar to voltage values shown in FIG. 6. The effect on addressing time is due to higher plate gap wall voltage Wad(A) prior to ramp down, similar to the effect of the embodiment of FIG. 5. If the previous sub-field is not addressed, the situation is similar to first operation condition of embodiment shown in FIG. 5.

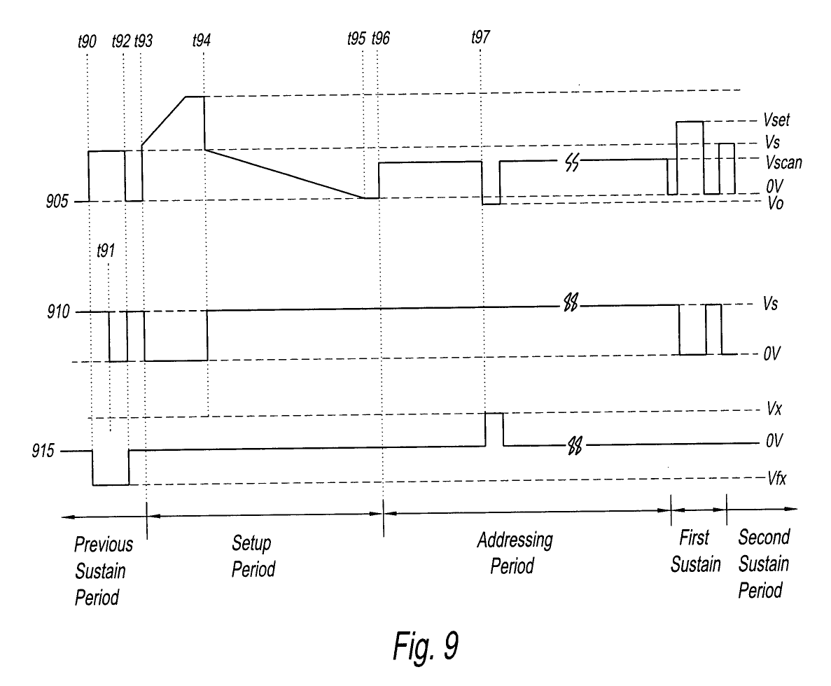

Referring to FIG. 9, another embodiment of the waveform of the present invention is provided. Waveform 905 represents voltages applied to scan electrode 112 over a period of time representing a sub-field, waveform 910 represents voltage applied to sustain electrode 111 over the period of time, and waveform 915 represents the voltage applied to data electrode 116 over the period of time. The waveform time period of each sub-field is divided into a previous sustain period, a ramp setup period, an addressing period, a first sustain period, and a second sustain period.

In this embodiment, the waveforms of FIG. 9 are similar to the waveforms of FIG. 5, except that the waveform of FIG. 9 does not include a quick increase in voltage on either scan electrode 112 or sustain electrode 111. In this embodiment, by applying a negative voltage Vfx on data electrode 116 during the previous sustain period, an additional and strong plate gap discharge occurs during the previous sustain period, and a build up of large plate gap wall voltage Wad(A), similar to Vwall4 in FIG. 6, is established.

In this embodiment, the setup period begins at time t93. Prior to the setup period, at time t90 through time t92, a sustain voltage pulse Vs is applied to scan electrode 112. A sustain voltage pulse Vs is also applied to sustain electrode 111 and reduced to zero at time t91. Between times t90 and t92, a negative voltage Vfx is applied to data electrode 116. A strong plate gap discharge occurs between scan electrode 112 and data electrode 116 at time t90 and a sustain gap discharge between scan electrode 112 and sustain electrode 111 at t91. A strong discharge across both plate gap and sustain gap occurs at t92. Discharge occurring at t90 and t92 increases the wall charges in plate gap 131 prior to the ramping up of voltage at time t93. The ramp in the time period of t93 to t95 helps to establish wall voltage both in the plate gap and the sustain gap close to breakdown voltage. The increased wall charge built up in the plate gap, as a result of the negative voltage applied to data electrode 116 also improves the priming condition of address discharge. As a result, a significant reduction of address time is achieved by this waveform.

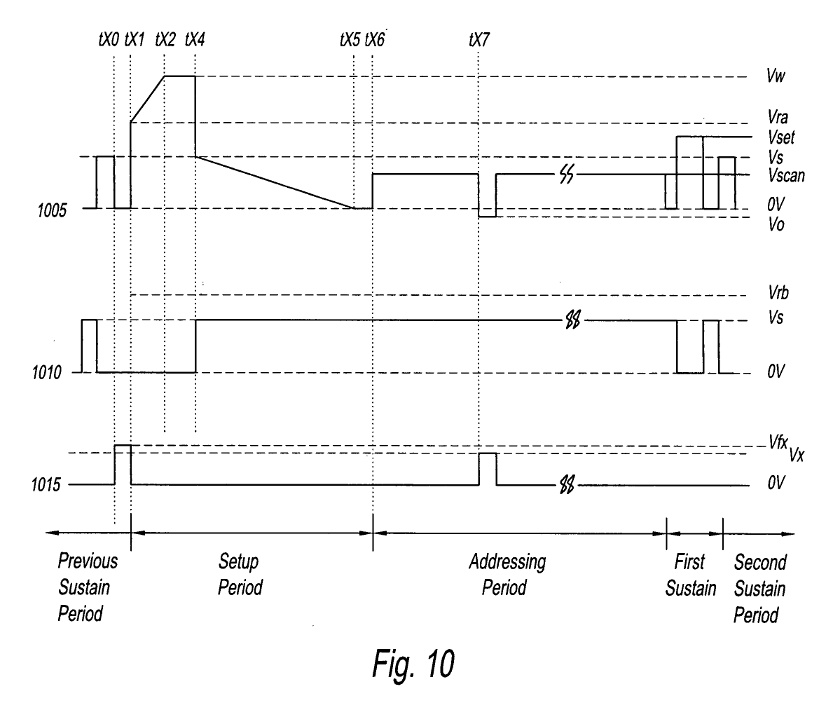

Referring to FIG. 10, yet another embodiment of the waveform of the present invention is provided. Waveform 1005 represents voltages applied to scan electrode 112 over a period of time representing a sub-field, waveform 1010 represents voltage applied to sustain electrode 111 over the period of time, and waveform 1015 represents the voltage applied to data electrode 116 over the period of time. The waveform time period of each sub-field is divided into a previous sustain period, a ramp setup period, an addressing period, a first sustain period, and a second sustain period.

In this embodiment, the waveforms of FIG. 10 are similar to the waveforms of FIG. 5. However, unlike FIG. 5, there is no voltage applied to sustain electrode 111 between times tX0 and tX4.

In this embodiment, a positive voltage Vfx is applied to data electrode 116 during a sustain pulse period immediately preceding the setup period. Positive voltage Vfx is applied to data electrode 116 between times tX0 and tX1. At time tX0, a sustain pulse applied during the preceding sustain period ends, and voltage Vfx is applied at time tX0 until time tX1, when the setup period begins.

Strong plate gap discharges and weak sustain gap discharges occur between time tX0 and tX1, as a result of the voltage increase on data electrode 116, before the ramping up period between times tX1 and tX4. These strong plate gap discharges help to establish wall charges in plate gap 131. The ramp setup period from tX0 to tX5, in conjunction with the voltage offset between scan electrode 112 and data electrode 116 between time tX0 and tX1, provides good wall voltages close to the breakdown voltage of both plate gap 131 and sustain gap 130. Thus, similar to previous embodiment, this embodiment of the waveform of the present invention can also achieve a very fast addressing discharge.

The present invention significantly reduces the address time by improving wall voltage establishment in both sustain gap and plate gap while retaining a low level of background glow. Wall voltage is induced by accumulation of wall charges induced in a sub-pixel. A fast address time has numerous benefits, including allowing for more time for more sub-fields which results in higher resolution, and allowing more time for sustain periods which increases brightness. As a result, higher brightness and higher resolution display can be achieved with the voltage levels equal to or less than those currently employed in the art to drive PDP's.

The present invention has been described with particular reference to the preferred embodiments. It should be understood that the foregoing descriptions and examples are only illustrative of the invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1. A method for controlling a pixel in a plasma display, comprising:
applying a first voltage to a first electrode, a second voltage to a second electrode, and a third voltage to a third electrode to generate a first plasma discharge of a dischargeable gas in said pixel;
applying a forth voltage to said first electrode, a fifth voltage to said second electrode, and a sixth voltage to said third electrode to generate a second plasma discharge of said dischargeable gas in said pixel,
wherein said first plasma discharge establishes a first wall potential between said first electrode and said third electrode, and
wherein said second plasma discharge establishes a second wall potential between said first electrode and said third electrode,
wherein said second wall potential is offset from said first wall potential.

2. The method of claim 1, wherein said first electrode is a scan electrode, said second electrode is a sustain electrode, and said third electrode is a data electrode.

3. The method of claim 1, wherein said first plasma discharge establishes said first wall potential between said first electrode and said second electrode, and
wherein said second plasma discharge establishes said second wall potential between said first electrode and said second electrode.

4. The method of claim 1, wherein the second plasma discharge results in a wall potential distribution across a plate gap between said first and third electrodes and/or across a sustain gap between said first and second electrodes, and
wherein said wall potential distribution resulting from said second plasma discharge is substantially increased relative to a wall potential distribution resulting from said first plasma discharge.

5. The method of claim 1, wherein said method is performed during a selected period of time,
wherein said period of time comprises a previous sustain period, a setup period, an addressing period a first sustain period and a second sustain period, and
wherein said first plasma discharge is generated during said previous sustain period occurring immediately prior to said setup period.

6. The method of claim 5, wherein said second plasma discharge is generated during said setup period.

7. The method of claim 5, wherein applying a forth voltage includes increasing said forth voltage, and applying said fifth voltage includes decreasing said fifth voltage, thereby achieving a potential difference between said first electrode and said second electrode sufficient to generate said second plasma discharge.

8. The method of claim 7, wherein applying said forth voltage includes gradual increasing a voltage applied to said first electrode during a ramping up period, and wherein said decreasing said fifth voltage occurs after said gradually increasing of voltage applied to said first electrode.

9. The method of claim 8, further comprising applying a sustain voltage to said second electrode prior to said ramping up period,
wherein applying said forth voltage includes increasing a voltage on said second electrode from said sustain voltage during a first portion of said ramping up period, and decreasing said voltage on said second electrode to a voltage level below said sustain voltage during a second portion of said ramping up period.

10. The method of claim 8, wherein applying said sixth voltage includes applying a negative voltage to said third electrode during said ramping up period.

11. The method of claim 5, wherein applying said forth voltage to said first electrode and applying said sixth voltage occurs during said previous sustain period,
wherein applying said forth voltage includes applying a positive voltage pulse to said first electrode, and
wherein applying said sixth voltage includes applying a negative voltage pulse to said third electrode.

12. The method of claim 5, wherein applying said forth voltage to said first electrode and applying said sixth voltage occurs during said previous sustain period,
wherein applying said forth voltage includes applying a positive voltage pulse to said first electrode, and
wherein applying said sixth voltage includes applying a positive voltage pulse to said third electrode after said positive voltage pulse is applied to said first electrode, and before said setup period.

13. A plasma display, comprising:
a first electrode, a second electrode, and a third electrode; and
a controller, wherein said controller:
applies a first voltage to said first electrode, a second voltage to said second electrode, and a third voltage to said third electrode to generate a first plasma discharge of a dischargeable gas in said pixel;
applies a forth voltage to said first electrode, a fifth voltage to said second electrode, and a sixth voltage to said third electrode to generate a second plasma discharge of said dischargeable gas in said pixel,
wherein said first plasma discharge establishes a first wall potential between said first electrode and said third electrode, and
wherein said second plasma discharge establishes a second wall potential between said first electrode and said third electrode,
wherein said second wall potential is offset from said first wall potential.

14. The plasma display of claim 13, wherein said first electrode is a scan electrode, said second electrode is a sustain electrode, and said third electrode is a data electrode.

15. The plasma display of claim 13, wherein the second plasma discharge results in a wall potential distribution across a plate gap between said first and third electrodes and/or across a sustain gap between said first and second electrodes, and
wherein said wall potential distribution resulting from said second plasma discharge is substantially increased relative to a wall potential distribution resulting from said first plasma discharge.

16. The plasma display of claim 13, wherein said controller applies said first, second, third, forth, fifth and sixth voltages during a selected period of time,
wherein said period of time includes a previous sustain period, a setup period, an addressing period and first sustain period, second sustain period, and
wherein said first plasma discharge is generated during said previous sustain period occurring immediately prior to said setup period.

17. The plasma display of claim 16, wherein said second plasma discharge is generated during said setup period.

18. The plasma display of claim 16, wherein applying a forth voltage includes increasing said forth voltage, and applying said fifth voltage includes decreasing said fifth voltage, thereby achieving a potential difference between said first electrode and said second electrode sufficient to generate said second plasma discharge.

19. The plasma display of claim 17, wherein applying said sixth voltage includes applying a negative voltage to said third electrode during said ramping up period.

20. A controller for a plasma display, comprising:
a module that applies a first voltage to a first electrode, a second voltage to a second electrode, and a third voltage to a third electrode to generate a first plasma discharge of a dischargeable gas in said pixel; and
applies a forth voltage to said first electrode, a fifth voltage to said second electrode, and a sixth voltage to said third electrode to generate a second plasma discharge of said dischargeable gas in said pixel,
wherein said first plasma discharge establishes a first wall potential between said first electrode and said third electrode, and
wherein said second plasma discharge establishes a second wall potential between said first electrode and said third electrode,
wherein said second wall potential is offset from said first wall potential.
